(19) United States
(12) Patent Application Publication
(10) Pub. No.: US 2014/0074673 A1
(43) Pub. Date: Mar. 13, 2014

(54) SYSTEM AND METHOD FOR MAINTAINING EMPLOYMENT ELIGIBILITY AND BANK CUSTOMER INFORMATION

(71) Applicant: First Data Corporation, Greewood Village, CO (US)

(72) Inventor: Robert B. Kirsh, Memphis, TN (US)

(73) Assignee: First Data Corporation, Greenwood Village, CO (US)

(21) Appl. No.: 14/024,691

(22) Filed: Sep. 12, 2013

Related U.S. Application Data
(60) Provisional application No. 61/699,967, filed on Sep. 12, 2012.

(51) Int. Cl. G06Q 40/00

(52) U.S. Cl. CPC G06Q 40/105
USPC 705/32; 705/320

(57) ABSTRACT

A payroll enrollment system collects data from one source but for different purposes. The enrollment system is operated by a third party for receiving personal data from an employee. On behalf of an employer, the enrollment system collects and retains employment eligibility data based on the entered personal data. Based on the same personal data, the enrollment system collects and retains bank customer identification data, on behalf of a financial institution, when an account at the financial institution is established by the enrollment system for receiving payroll deposits.

### CROSS-REFERENCES TO RELATED APPLICATIONS

This application claims the benefit of and is a non-provisional of U.S. Provisional Patent Application No. 61/699,967, entitled “SYSTEM AND METHOD FOR MAINTAINING EMPLOYMENT ELIGIBILITY AND BANK CUSTOMER INFORMATION” filed Sep. 12, 2012, which is incorporated by reference in its entirety for all purposes.

### BACKGROUND OF THE INVENTION

Companies collect and maintain many types of data, often pursuant to legal or regulatory requirements. Examples are employment eligibility data (relating to Form 1-9 administered by the U.S. Department of Homeland Security) that is required to be collected and maintained by an employer for all its employees, under regulations promulgated pursuant to U.S. immigration laws, such as the Immigration Reform and Control Act of 1986 (Pub Law No. 99-603). Another example is customer identification program data (relating to a valid name, address, social security number for account holders), that is required to be collected by a financial institution when a customer opens a new account, under regulations promulgated pursuant to U.S. banking laws, such as those found in the USA Patriot Act (Public Law No. 107-56) and the Bank Secrecy Act (Public Law No. 91-5081).

There is cost and effort associated with collecting and maintaining data. Sometimes similar data needs to be collected, such as data that companies might be required to collect and maintain for their employees or customers. For example, similar data may be collected by two different companies that relates to the same person, e.g., a person that is an employee of one company and, at the same time, is a customer of a different company. However, it can be burdensome to maintain data on the same person for different purposes. For example, data relating to the same person might need to be retained for different periods of times, depending on the regulatory framework involved (e.g., data relating to an employee may need to be maintained for a different period of time than data relating to a customer).

There has arisen the need for reducing the cost and work that companies incur in both collecting and maintaining data.

### BRIEF SUMMARY OF THE INVENTION

There is provided, in accordance with embodiments of the present invention, a system and method for collecting data from one source and maintaining the data for at least two different proposes.

In one embodiment, a method is provided for collecting and maintaining data for two different entities, wherein the data comprises identifying information relating to the same subject but that is required to be collected and maintained under plural, different regulatory requirements. The method includes receiving, at a third party system that is operated by a third party that is not one of the two different entities, a first set of data entered at a user device for the subject and required for collection by a first entity of the two entities under one of the plural regulatory requirements, and determining at the third party system if the first set of data is verified as valid. The method further includes, if the first set of data is verified, capturing, at the third party system, a second set of data from the first set of data, the second set of data relating to the same subject and required for collection by a second entity of the two entities under a second of the plural regulatory requirements, storing, at the third party system and on behalf of the first entity, the first set of data, and storing, at the third party system and on behalf of the second entity, the second set of data, the second set of data stored as a data record separate from the first set of data.

A more complete understanding of the present invention may be derived by referring to the detailed description of the invention and to the claims, when considered in connection with the Figures.

### BRIEF DESCRIPTION OF THE DRAWINGS

FIG. 1 is a general block diagram showing a payroll distribution system connected to various external databases and systems, in accordance with one embodiment of the invention.

FIG. 2 illustrates details of the payroll enrollment system seen in FIG. 1.

FIG. 3 is a flow diagram illustrating one embodiment of a process implemented at the payroll enrollment system seen in FIG. 2.

FIG. 4 is a block diagram illustrating an exemplary computer system upon which embodiments of the present invention may be implemented.

### DETAILED DESCRIPTION OF THE INVENTION

Embodiments of the invention are directed to the collection and storage of data, such as data retained for regulatory or other legal purposes. In one embodiment, the data is entered by a user when enrolling with a payroll enrollment system operated by a third party on behalf of an employer. The entered data is used to collect both employment eligibility data (for the employer) and customer identification program data (for a financial institution establishing an account for the employee).

More specifically, during enrollment with the payroll enrollment system, the user (employee) is permitted to have an account established for purposes of receiving payroll deposits (e.g., if the user does not have an existing account with a bank or other financial institution). The account may be a debit checking account maintained at a financial institution. In the described embodiment, data entered by the user is collected and retained for two different purposes, namely, data for (1) employment eligibility that is required by the U.S. government to be collected and retained by an employer, evidencing that the employee is eligible to work in the U.S., and (2) bank customer identification that is required by the U.S. government to be collected and retained by financial institutions (under the so-called “Customer Identification Program”), evidencing the true identity of the customer (the employee) for whom an account is being established. The data entered by the user is verified by accessing public databases, such as databases used for verifying 1-9 information under the “E-Verify” system. Thus, one set of data entered and provided by an employee to the payroll enrollment system may be collected, verified and retained for both employment eligibility and bank customer identification purposes.

While in the described embodiment data is collected for purposes of employment eligibility and bank customer identification, it should be appreciated that other data collection purposes are possible within the scope of the invention. Thus, embodiments may be generally directed to collection of any data by a third party and retained by the third party on behalf of different entities and for different purposes.

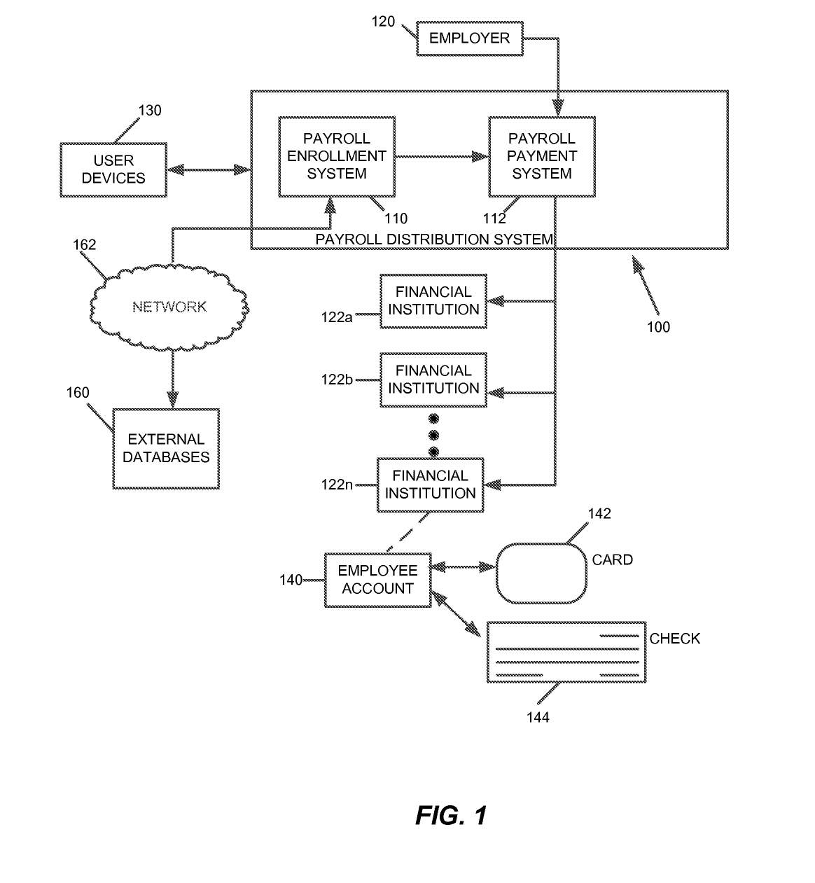

There are various configurations for implementing the present invention. One such implementation is shown in FIG. 1, illustrating a payroll distribution system 100 that includes a payroll enrollment system 110 and a payroll payment system 112.

In general, the purpose of the payroll distribution system 100 is to permit employees to enroll in the payroll system of their employer 120 (e.g., when beginning employment), and then thereafter to have payroll administered and paid.

In embodiments described herein, the payroll distribution system 100 is operated by a third party payroll distribution service that makes arrangements for payroll amounts to be deposited electronically for the benefit of the employee into accounts that are maintained on behalf of the employee.

Thus, the payroll distribution system 100 is connected to various financial institutions 122 that may maintain accounts for employees. The financial institutions may include banks, credit unions, brokerage firms or any other type of financial institutions where payroll deposits may be made. Employees may enter personal information at user devices 130 for purposes of enrolling with the system 100. The enrollment is processed by the payroll enrollment system 110. The personal information provided by an employee may include the employee's name, address, date of birth, social security number, tax information (such as withholding information), and any other information necessary for the employer 120 to add the employee to the payroll, such as the bank routing number and account number for a personal bank account, if the employee has an existing account for payroll checks to be electronically deposited (e.g., through an ACH deposit transaction).

In some embodiments, the system 100 may be operated by the employer 120, rather than a third party payroll distribution service.

In accordance with one aspect of the invention, the entity that operates the system 100 may offer a service through which an account 140 is set up for payroll purposes for an employee at one of the financial institutions 122 (such as the financial institution 122n illustrated in FIG. 1). The account 140 may be a prepaid checking account into which amounts are automatically deposited through the payroll distribution system 100. Such accounts have the advantage of serving the needs of employees that do not have an existing bank account, for example, because the employee has no relationship with a bank and normally uses cash to conduct transactions, or perhaps the employee does not qualify for a traditional bank account because the employee's credit worthiness. In some instances, the account may be set up by an employer as a convenient form of payroll payment, eliminating the need for paper payroll checks.

When such an account (such as the account 140) is set up for an employee, the employee may access money in the account through a debit card 142 or other form of presentation instrument (provided to the employee when beginning employment), or through the use of pre-printed checks 144 (e.g., having the employee's name, address and account number, printed thereon) that are provided to the employee at the time the account is set up. As an example, if the employee wants to write a check, he or she enters the check amount on one of the pre-printed checks 144 and calls the entity maintaining the account to provide the check amount and obtain a transaction number that is then entered on the check. The transaction number reflects that funds from the account 140 have been allocated to the check, and assures the payee that the amount of the check will be paid. Such systems make check cashing easy for the employee, since funds are pre-allocated to the check before it is used or cashed. In addition, the availability of a check 144 may satisfy legal requirements in some jurisdictions that an employee have a paper check issued for payroll.

Services for establishing and maintaining prepaid accounts for payroll purposes are offered by various entities, such as Money Network, a business unit of First Data Corporation, Atlanta, Ga. Systems and methods used in providing such services are known and described, for example in U.S. Pat. No. 7,475,811, issued on Jan. 13, 2009 to Jackman et al., and U.S. Pat. No. 7,658,322, issued on Feb. 9, 2010, to Jackman et al.

Under current laws in the U.S., when an employee is hired, the employer must collect and maintain certain personal information from the employee and use that information (and supporting documents, such as a driver's license and social security card) to verify that the employee is eligible to work in the U.S. Such information may be collected and stored in paper form (e.g., on Form 1-9), or may be collected and stored electronically. In embodiments herein, such personal information may be collected electronically from the employee (at one of the user devices 130) at the time that an employee enrolls at the payroll distribution system 100, e.g., as a condition to being hired. The employee thereafter provides supporting documents for an employer to examine, and the employer may enter data (at one of the user devices 130) certifying that the supporting documents have been examined and that they appear to be genuine.

Also, current banking laws in the U.S. require that when a financial account is set up at a bank or other financial institution for a customer of financial institution (such as account 140, set up to receive payroll payments), the institution must also collect and verify personal information regarding the customer. In accordance with embodiments herein, such information may also be collected, verified and maintained at the system 100.

After an employee is enrolled with the payroll distribution system, the employer 120 periodically provides payroll information (e.g., gross wages, hours worked, deductions, etc.) to the payroll payment system 112, which in turn calculates net payroll amounts (e.g., after withholding taxes and other items from gross pay), thus enabling the payroll payment system 112 to issue payroll checks to employees, such as by electronic deposits to accounts of employees at the various financial institutions 122.

Also seen in FIG. 1 are external databases which are accessed by the payroll enrollment system 110 through a network 162, which may be a private network or a public network, such as the internet. In one embodiment, the external databases may be those operated by a governmental entity for purposes of verifying the personal data entered by an employee at one of the user devices 130. For example, the United States Department of Homeland Security (U.S. Citizenship and Immigration Services) operates the “E-Verify” system that permits an employer, through an internet-based connection, to verify personal information provided by an employee against database records maintained by the Social Security Administration and the Department of Homeland Security. If the personal data is verified (e.g., the provided information appears to be valid and relate to an actual person eligible to work in the United States), the E-Verify system returns a confirmation that is retained as a record (along with the underlying personal information) by the employer. The employer also maintains, as part of the record, confirmation that the employer has inspected supporting documents (e.g., driver's license and social security card) that have been produced by the employee. The resulting record (personal information, confirmation returned by the E-Verify system, and information/certification entered by the employer after inspecting supporting documents provided by the employee) is then stored at the system 100 in a manner to be described shortly.

As will also be described shortly, the same data (or information derived from the same data) may also be stored separately at system 100 as bank customer identification data.

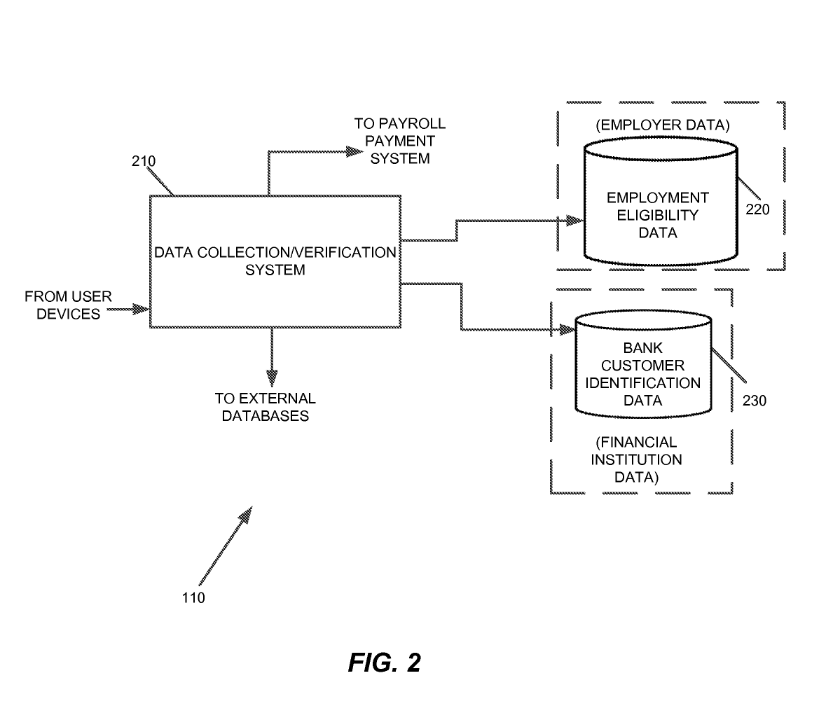

Turning now to FIG. 2, there is illustrated in greater detail the payment enrollment system 110 seen in FIG. 1. As illustrated, the system 110 includes a data collection/verification system 210. The system 210 collects data (e.g., received from user devices 130), transmits personal information to external databases (such as the external databases 160 seen in FIG. 1) for verification, and provides payroll information to the payroll payment system 112 (as described earlier, information necessary for the payroll payment system 112 to calculate and send payroll deposits to the financial institutions 122). As also illustrated in FIG. 2, the system 110 includes two databases, an employment eligibility database 220 and a bank customer identification database 230. As will be described shortly in greater detail, when data is captured at the data collection/verification system 210 (e.g., in response to an employee entering personal information at one of the user devices 130), that data (or some portion of it) is stored at the database 220 (for the benefit of the employer, for later access if requested for employment verification purposes) and also stored at the database 230 (for the benefit of a financial institution, for later access if needed for bank customer identification purposes). Thus, data entered by an employee is captured and stored at system 210 for two different purposes, namely, data “owned” by (or stored on behalf of) the employer and pertaining to the employment eligibility of the employee, and data “owned” by (or stored on behalf of) a financial institution and pertaining to an account that may have been set up for deposit of payroll payments for the same employee (as a bank customer). As should be appreciated, the information stored in each of the databases 220 and 230 is derived from the same source (i.e., the data entered at one of the user devices 130). Data entered once will yield both employer data (stored at database 220) and financial institution data (stored at database 230). Thus, the system 210 is configured to efficiently collect, store and make accessible data for two different legal/regulatory purposes.

It should be appreciated that, among other reasons, the data is stored separately at databases 220 and 230 because the data in each database may need to be stored (for access, upon governmental request) for different periods of time. For example, employment eligibility data is currently required to be retained for one year after employment termination, or three years after employment commencement, whichever is longer, whereas bank customer identification data is required to be retained for five years after the account in question is closed.

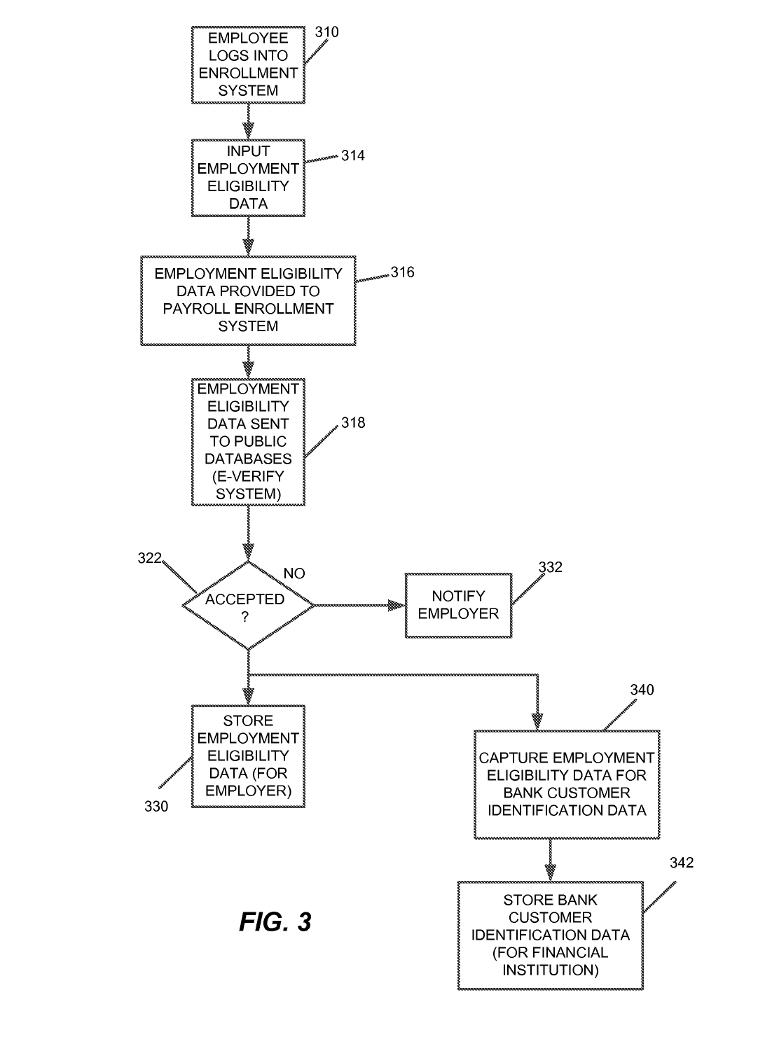

FIG. 3 illustrates a general process implemented at the payroll enrollment system 100, in accordance with one embodiment. At step 310, an employee at one of the user devices 130 logs into the enrollment system 110 and then, at step 314, enters personal data (employment eligibility data), along with any other information that the employer may require to begin employment and issue payroll checks (e.g., tax withholding information, such as required for electronically filling out IRS form W-4). The entered employment eligibility data is provided, at step 316, to the payroll enrollment system 110. In one exemplary embodiment, the employment eligibility data includes name, address, social security number and date of birth, since under current regulatory requirements, such data is required for 1-9 (employment eligibility) purposes. However, as should be appreciated, the same data (or some portion of it) may also be useful (or required) for bank customer identification purposes.

If the employee has an existing bank account into which payroll deposits will be made (i.e., the employee does not need account 140 set up during enrollment), account identifying data (such as a routing number and an account number for the existing account) may also be entered at step 314.

At step 318, the employment eligibility data is sent to public databases, such as through the E-Verify system to databases maintained by the Social Security Administration and the Department of Homeland Security. If the personal data is, at step 322, accepted by such databases as genuine (it matches data associated with a valid social security number and is not associated with suspicious or fraudulent activity), then the personal data (as well as returned confirmation data from the public databases) is stored (by the third party operating the payroll enrollment system 110) on behalf of the employer for employment eligibility verification purposes, step 330. Although not shown, it should be appreciated that employers are also required (at the time that employment commences) to examine supporting documents received from the employee (e.g., driver's license and social security number), and data confirming the examination of such documents will be stored as part of the same record for the employer at step 330.

If the supplied personal data is not accepted at step 322, the employer is notified (step 332) and the employee is prevented from enrolling at the payroll system until proper eligibility data is supplied.

In the process illustrated in FIG. 3, it is assumed that the employee either does not have or does not want to use an existing personal bank account for payroll deposit payments and thus, as part of the enrollment process, an account is established by the payroll enrollment system in order for the employee to receive payroll deposits (such as the account 140 seen in FIG. 1). The financial institution 122n maintaining that account is required to collect, verify and retain bank customer identification data. Thus, at step 340, the same personal data (name, address, social security number and date of birth) and the confirmation data (confirming the validity of the personal data) received from the public databases is processed or parsed as necessary in order to capture bank customer identification data (step 340), which is then stored separately as bank customer identification data at the database 230, step 342. This data is stored (by the third party operating the payroll enrollment system 110) on behalf of the financial institution at which the account 140 has been established.

It should be noted that the data is evaluated at step 340 to identify and capture only that data that is required for bank customer identification purposes. Under current regulations, bank customer identification data can be the same personal data entered by the user at step 314 (name, address, social security number and date of birth) and also returned electronic confirmation that the personal data has been verified against a public database (step 318). Thus, in some cases the data stored at step 330 (for employment eligibility verification purposes) may in fact be the same as the data stored at step 342 (for bank customer identification purposes). However, in other embodiments, depending on the applicable regulation and the customary practices of financial institutions at the time of data collection, the data stored (for the financial institution) at step 342 may be less (or more) than the data stored at step 330 (for the employer). In such case, the system 110 may be programmed to evaluate the employment eligibility data (and other data) entered at step 340, in order to derive and collect the necessary data needed for storing data (as customer identification data) at step 342.

In some cases, where additional data is needed for customer identification data (beyond that needed for employment eligibility data stored at step 330), the enrollment system 110 may request additional information from the employee to augment the employment eligibility data in order to have complete customer identification data to be stored at step 342.

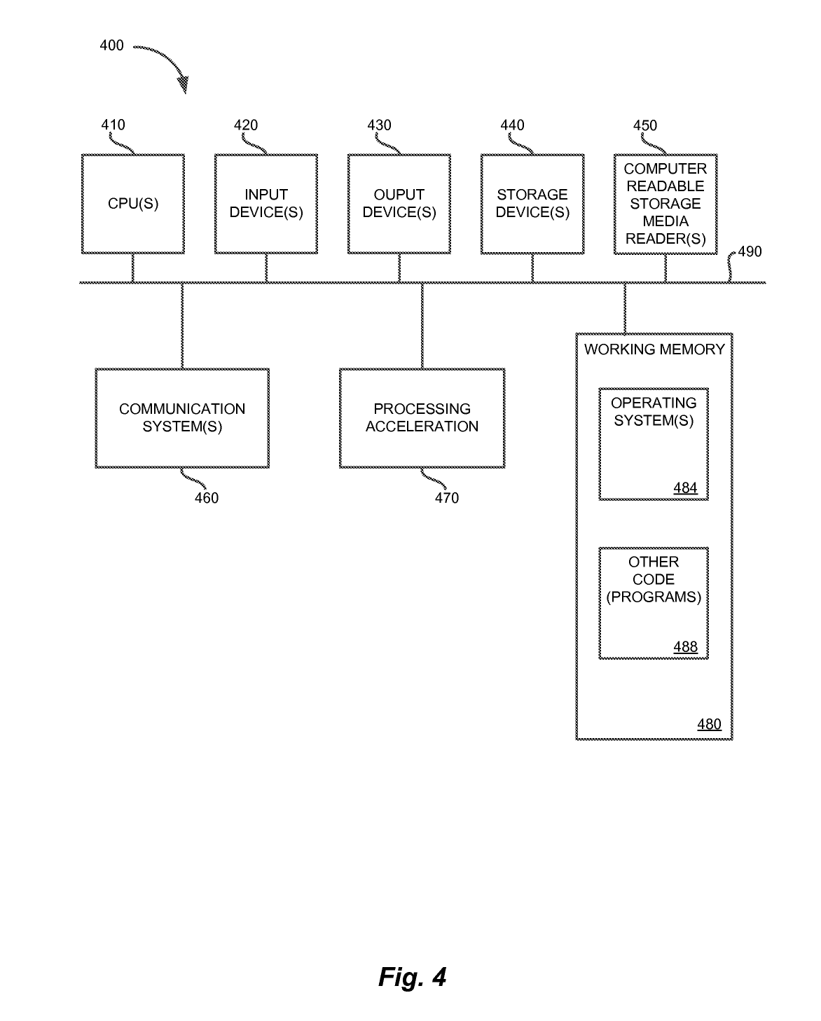

FIG. 4 is a block diagram illustrating an exemplary computer system upon which embodiments of the present invention may be implemented. This example illustrates a computer system 400 such as may be used, in whole, in part, or with various modifications, to provide the functions of the payroll enrollment system 110, payroll payment system 112, and user devices 130, as well as other components and functions of the invention described herein.

The computer system 400 is shown comprising hardware elements that may be electrically coupled via a bus 490. The hardware elements may include one or more central processing units 410, one or more input devices 420 (e.g., a mouse, a keyboard, etc.), and one or more output devices 430 (e.g., a display device, a printer, etc.). The computer system 400 may also include one or more storage devices 440, representing remote, local, fixed, and/or removable storage devices and storage media for temporarily and/or more permanently containing computer-readable information, and one or more storage media reader(s) 450 for accessing the storage device(s) 440. By way of example, storage device(s) 440 may be disk drives, optical storage devices, solid-state storage device such as a random access memory (“RAM”) and/or a read-only memory (“ROM”), which can be programmable, flash-updateable or the like.

The computer system 400 may additionally include a communications system 460 (e.g., a modem, a network card—wireless or wired, an infra-red communication device, a Bluetooth™ device, a near field communications (NFC) device, a cellular communication device, etc.) The communications system 460 may permit data to be exchanged with a network, system, computer, mobile device and/or other component as described earlier. The system 400 also includes working memory 480, which may include RAM and ROM devices as described above. In some embodiments, the computer system 400 may also include a processing acceleration unit 470, which can include a digital signal processor, a special-purpose processor and/or the like.

The computer system 400 may also comprise software elements, shown as being located within a working memory 480, including an operating system 484 and/or other code 488. Software code 488 may be used for implementing functions of various elements of the architecture as described herein. For example, software stored on and/or executed by a computer system, such as system 400, can be used in implementing the processes seen in FIG. 3.

It should be appreciated that alternative embodiments of a computer system 400 may have numerous variations from that described above. For example, customized hardware might also be used and/or particular elements might be implemented in hardware, software (including portable software, such as applets), or both. Furthermore, there may be connection to other computing devices such as network input/output and data acquisition devices (not shown).

While various methods and processes described herein may be described with respect to particular structural and/or functional components for ease of description, methods of the invention are not limited to any particular structural and/or functional architecture but instead can be implemented on any suitable hardware, firmware, and/or software configuration. Similarly, while various functionalities are ascribed to certain individual system components, unless the context dictates otherwise, this functionality can be distributed or combined among various other system components in accordance with different embodiments of the invention. As one example, the payroll enrollment system 110 and payroll payment system 112 may be implemented by a single system having one or more storage device and processing elements. As another example, the payroll enrollment system 110 and payroll payment system 112 may each be implemented by plural systems, with their respective functions distributed across different systems either in one location or across a plurality of linked locations.

Moreover, while the various flows and processes described herein (e.g., those illustrated in FIG. 3) are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments may be described with (or without) certain features for ease of description and to illustrate exemplary features, the various components and/or features described herein with respect to a particular embodiment can be substituted, added, and/or subtracted to provide other embodiments, unless the context dictates otherwise. Further, the term “exemplary” used herein does not mean that the described example is preferred or better than other examples.

Consequently, although the invention has been described with respect to exemplary embodiments, it will be appreciated that the invention is intended to cover all modifications and equivalents within the scope of the following claims.

What is claimed is:

1. A method for collecting and maintaining data for two different entities, wherein the data comprises information relating to the same subject but that is required to be collected and maintained under plural, different requirements, the method comprising:
receiving, at a third party system that is operated by a third party that is not one of the two different entities, a first set of data entered at a user device for the subject and required for collection by a first entity of the two entities under one of the plural, different requirements;
determining at the third party system if the first set of data is verified as valid;
if the first set of data is verified, capturing, at the third party system, a second set of data from the first set of data, the second set of data relating to the same subject and required for collection by a second entity of the two entities under a second of the plural, different requirements;
storing, at the third party system and on behalf of the first entity, the first set of data; and
storing, at the third party system and on behalf of the second entity, the second set of data, the second set of data stored as a data record separate from the first set of data.

2. The method of claim 1, wherein the second set of data comprises at least a portion of the first set of data.

3. The method of claim 1, wherein the second set of data is derived from the first set of data after it is received at the third party system and determined verified.

4. The method of claim 1, wherein the plural, different requirements are plural, different regulatory requirements, and wherein the method further comprises:
upon request, providing, by the third party system, access to the first set of data by the first entity pursuant to a first one of the plural, different regulatory requirements; and
upon request, providing, by the third party system, access to the second set of data by the second entity pursuant to another of a second one of the plural, different regulatory requirements.

5. The method of claim 1, wherein the subject is a person that is both an employee of the first entity and a bank customer of the second entity.

6. The method of claim 1, wherein the first set of data is personal data relating to the person.

7. The method of claim 6, wherein the first set of data is at least one or more of a name, address, social security number and date of birth.

8. The method of claim 1, wherein the third party system is a payroll enrollment system, and wherein, if the first set of data is not verified, the payroll system prevents the employee from enrolling for payroll at the payroll system.

9. The method of claim 1, wherein the plural, different regulatory requirements comprise (1) a requirement under which an employer must verify the eligibility of an employee to work in a country, and (2) a requirement under which a financial institution must verify the identity of a person opening a financial account, and wherein the person opening the financial account is the employee.

10. The method of claim 9, further comprising:
if the first set of data is verified, providing, by the third party system for election by the employee, an option to deposit payroll money into the financial account, wherein amounts deposited into the financial account may be accessed either by presentation instrument or by negotiable instrument.

11. The method of claim 9, wherein the second set of data is stored as a separate data record from the first set of data in order to maintain the first and second sets of data for different periods of time, as required under the plural, different requirements.

12. A method for collecting and maintaining employment eligibility verification data and bank customer identification data, comprising:
on behalf of an employer, collecting, at a payroll payment enrollment system, personal identifying data identifying a prospective employee;
accessing a database external to the payroll payment enrollment system, in order to verify the accuracy of the personal identifying data;
verifying, at the payroll payment enrollment system, the personal identifying data based on accessing the external database;
if the personal identifying data is verified, evaluating, at the payroll payment enrollment system and on behalf of a financial institution, the personal identifying data in order to collect bank customer identification data;
storing, at the payroll payment enrollment system and on behalf of the employer, the personal identifying data and verification data reflecting that the personal identifying data has been verified; and
storing, at the payroll payment enrollment system and on behalf of the financial institution, the collected bank customer identification data and the verification data, the collected bank customer identification data and the verification data stored on behalf of the financial institution stored as a data record separate from the personal identifying data and verification data stored on behalf of the employer.

13. A method for collecting and maintaining employment eligibility data and bank customer identification data that have each been verified for access upon request of a government agency, comprising:
receiving, by a payroll system and of behalf of an employer, personal identifying data of an employee or prospective employee;
verifying, by the payroll system, the validity of the personal identifying data by accessing an external public database;
storing, by the payroll system and on behalf of the employer, the personal identifying data and verification data reflecting the personal identifying data as being verified;
if the personal identifying data is verified, providing, by the payroll system and for election by the employee, an option to deposit payroll money into a financial account, wherein amounts deposited into the financial account may be accessed either by presentation instrument or by negotiable instrument; and
if the option for deposit into the financial account is elected, capturing at least a portion of the personal identifying data and the verification data, and storing by the payroll system and on behalf of the financial institution, as customer bank verification data, the personal identifying data and the verification data.

14. A system for collecting and maintaining data for two different entities, wherein the data comprises information relating to the same subject but that is required to be collected and maintained under plural, different requirements, the system comprising:
a processor; and
a memory, the memory having stored therein a sequence of instructions which, when executed by the processor, cause the processor to:
receive, at a third party system that is operated by a third party that is not one of the two different entities, a first set of data entered at a user device for the subject and required for collection by a first entity of the two entities under one of the plural, different requirements;
determine at the third party system if the first set of data is verified as valid;
if the first set of data is verified, capture, at the third party system, a second set of data from the first set of data, the second set of data relating to the same subject and required for collection by a second entity of the two entities under a second of the plural, different requirements;
store, at the third party system and on behalf of the first entity, the first set of data; and
store, at the third party system and on behalf of the second entity, the second set of data, the second set of data stored as a data record separate from the first set of data.

15. The method of claim 14, wherein the second set of data comprises at least a portion of the first set of data.

16. The method of claim 14, wherein the second set of data is derived from the first set of data after it is received at the third party system and determined verified.

17. The method of claim 14, wherein the plural, different requirements are plural, different regulatory requirements, and wherein the method further comprises:
upon request, providing, by the third party system, access to the first set of data by the first entity pursuant to a first one of the plural, different regulatory requirements; and
upon request, providing, by the third party system, access to the second set of data by the second entity pursuant to another of a second one of the plural, different regulatory requirements.

18. The method of claim 14, wherein the subject is a person that is both an employee of the first entity and a bank customer of the second entity.

19. The method of claim 14, wherein the first set of data is personal data relating to the person.

20. The method of claim 19, wherein the first set of data is at least one or more of a name, address, social security number and date of birth.

21. The method of claim 14, wherein the third party system is a payroll enrollment system, and wherein, if the first set of data is not verified, the payroll system prevents the employee from enrolling for payroll at the payroll system.

22. The method of claim 14, wherein the plural, different regulatory requirements comprise (1) a requirement under which an employer must verify the eligibility of an employee to work in a country, and (2) a requirement under which a financial institution must verify the identity of a person opening a financial account, and wherein the person opening the financial account is the employee.

23. The method of claim 22, further comprising:
if the first set of data is verified, providing, by the third party system for election by the employee, an option to deposit payroll money into the financial account, wherein amounts deposited into the financial account may be accessed either by presentation instrument or by negotiable instrument.

24. The method of claim 22, wherein the second set of data is stored as a separate data record from the first set of data in order to maintain the first and second sets of data for different periods of time, as required under the plural, different requirements.
